(19) United States
(12) Patent Application Publication
(10) Pub. No.: US 2014/0248796 A1
(43) Pub. Date: Sep. 4, 2014

(54) RECEPTACLE CONNECTOR

(71) Applicant: HON HAI PRECISION INDUSTRY CO., LTD., New Taipei (CN)

(72) Inventor: FENG PAN, Kunshan (CN)

(73) Assignee: HON HAI PRECISION INDUSTRY CO., LTD., New Taipei (TW)

(21) Appl. No.: 14/195,002

(22) Filed: Mar. 3, 2014

(30) Foreign Application Priority Data
Mar. 1, 2013 (CN) 201310064886.1

(51) Int. Cl. H01R 13/514

(52) U.S. Cl. CPC H01R 13/514
USPC 439/540.1

(57) ABSTRACT

A receptacle connector (100) including a number of frames 12 transversely stacked together, each frame comprising: a conductive housing (120); a number of insulating stabilizers (3) mounted in the conductive housing; and plural differential pairs of contacts (4) each separately molded in a corresponding stabilizer, each contact of a differential pair of contacts having an outer edge (404) embedded into the stabilizer, an opposing inner edge (405), and two side edges (406) each connecting the inner edge and the outer edge, said side edge at least partially exposing to air; wherein each differential pair of contacts have different regions spaced different distances.

### CROSS-REFERENCE TO RELATED APPLICATIONS

The present application relates to U.S. application Ser. No. 13/772,232, filed Feb. 20, 2013.

### BACKGROUND OF THE INVENTION

1. Field of the Invention

The present disclosure relates to a backplane receptacle connector, and more particularly to a backplane receptacle connector having an improved frame.

2. Description of Related Art

U.S. Pat. No. 6,379,188 issued to Cohen et al. on Apr. 30, 2002 discloses a receptacle connector mounted on a daughter board for transferring differential signals to and from a header on a backplane or main circuit board. The receptacle connector has plural lead frames transversely stacked together. Each lead frame has a plurality of signal contacts or leads molded in a plastic housing. Windows are provided over leads to equalize the delay for signals traveling in long leads of each differential pair. As disclosed, it is not necessary that the “window” extend all the way to the surface of the conducting signal contact. Also, the “window” could be partially filled with plastic and partially filled with air, which would still have the effect of lowering the effective dielectric constant of the material above the long leg. Moreover, to counter one drawback of placing a window in the dielectric material, namely changing the impedance of the signal contact in the region below the window, other adjustments can be made to keep the impedance constant along the length of the signal conductors. One way that the impedance can be kept constant is by changing the width of the signal conductors. The signal conductors may have a width in one region and a broader width in the region of the windows. The dimensions are chosen to match the impedance based on the relative dielectric constant between the two regions. The technique of altering the width of the signal contacts in window regions is useful regardless of why the window is formed in the connector and is not limited to windows formed to equalize delay. As disclosed, some prior art connectors use windows over substantial portions of all the signal contacts to increase impedance of all the signal contacts.

U.S. Pat. No. 6,293,827 issued to Stokoe on Sep. 25, 2001 discloses a receptacle connector including a plurality of wafers or frames. The frame has a plurality of differential pairs of signal conductors. Air space may be provided between intermediate portions of each pair to increase the coupling between the signal conductors in a pair, which might reduce noise in a differential configuration. Alternatively, air space might increase the impedance of the differential pair. As disclosed, in connector design, it is often desirable for the impedance of the signal conductors to match the impedance of traces in a printed circuit board to which the connector is attached. Thus, in some cases it will be desirable to adjust the shape of the housings in the vicinity of the signal conductors in order to adjust the impedance.

A receptacle connector having an improved frame structure is desired.

### SUMMARY OF THE INVENTION

Accordingly, an object of the present invention is to provide a receptacle connector having an improved lead frame.

In order to achieve the object set forth, a receptacle connector comprises a plurality of frames transversely stacked together, each frame comprising: a conductive housing; a plurality of insulating stabilizers mounted in the conductive housing; and plural differential pairs of contacts each separately molded in a corresponding stabilizer, each contact of a differential pair of contacts having an outer edge embedded into the stabilizer, an opposing inner edge, and two side edges each connecting the inner edge and the outer edge, said side edge at least partially exposing to air; wherein each differential pair of contacts have different regions spaced different distances.

Each differential pair of contacts are spaced: a first distance between the inner edges where each contact has both side edges partially exposed to air and the inner edge totally exposed to air; a second distance between the inner edges where each contact has one side edge partially exposed to air and the inner edge at least partially exposed to air; and a third distance between the inner edges where each contact has only one side edge partially exposed to air; wherein the first distance is less than the second distance, and the second distance is less than the third distance.

Other objects, advantages and novel features of the invention will become more apparent from the following detailed description when taken in conjunction with the accompanying drawings.

### BRIEF DESCRIPTION OF THE DRAWINGS

FIG. 1 is an assembled perspective view showing a receptacle connector in accordance with the present invention;

FIG. 2 is an assembled perspective view showing a header for mating with the receptacle connector;

FIG. 3 is a partially assembled perspective view showing the receptacle connector of FIG. 1, with one frame thereof separated out;

FIG. 4 is an exploded view showing the frame as shown in FIG. 3;

FIG. 5 is another exploded view of the frame as shown in FIG. 3;

FIG. 6 is an exploded view showing a conductive housing and an insulating spacer seen in FIG. 4;

FIG. 7 shows a contact module as shown in FIG. 4;

FIG. 8 is a side view of the contact module as shown in FIG. 7;

FIG. 9 is a view similar to FIG. 8, omitting an insulating stabilizer thereof;

FIG. 10A is a cross-sectional view of the contact module taken along line A-A in FIG. 8;

FIG. 10B is a cross-sectional view of the contact module taken along line B-B in FIG. 8;

FIG. 10C is a cross-sectional view of the contact module taken along line C-C in FIG. 8;

FIG. 10D is a cross-section of the contact module taken along line D-D in FIG. 8; and

FIG. 11A-11D are views similar to FIG. 10B, showing respective cross-sections of varied designs of the insulating stabilizer according to various embodiments of the present invention.

### DETAILED DESCRIPTION OF THE PREFERRED EMBODIMENT

Reference will now be made in detail to the preferred embodiment of the present invention.

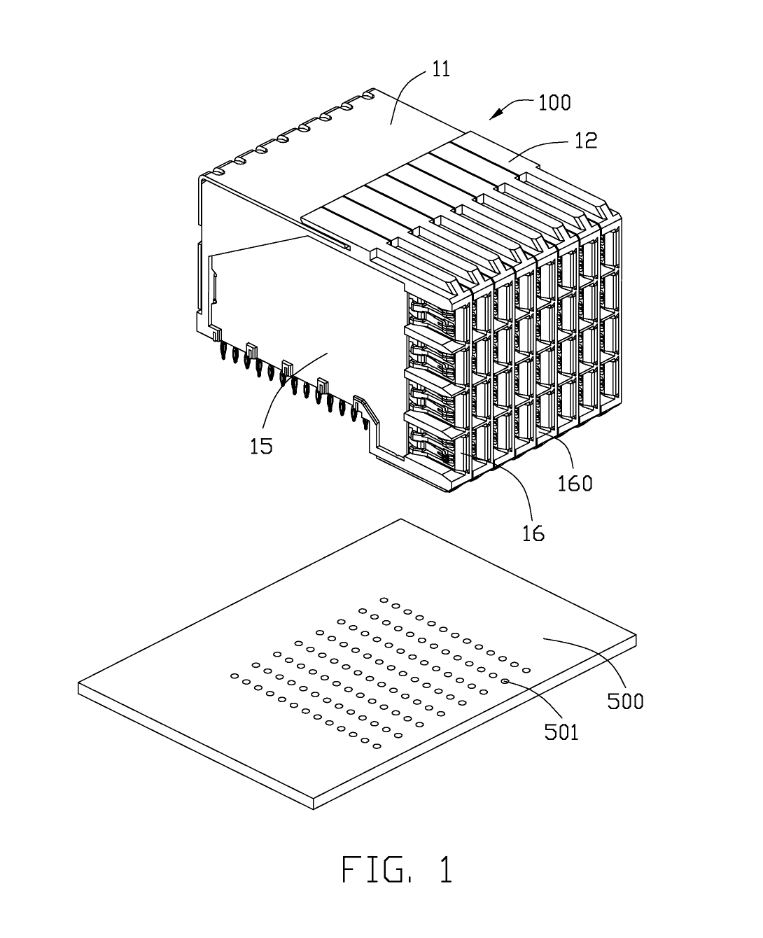

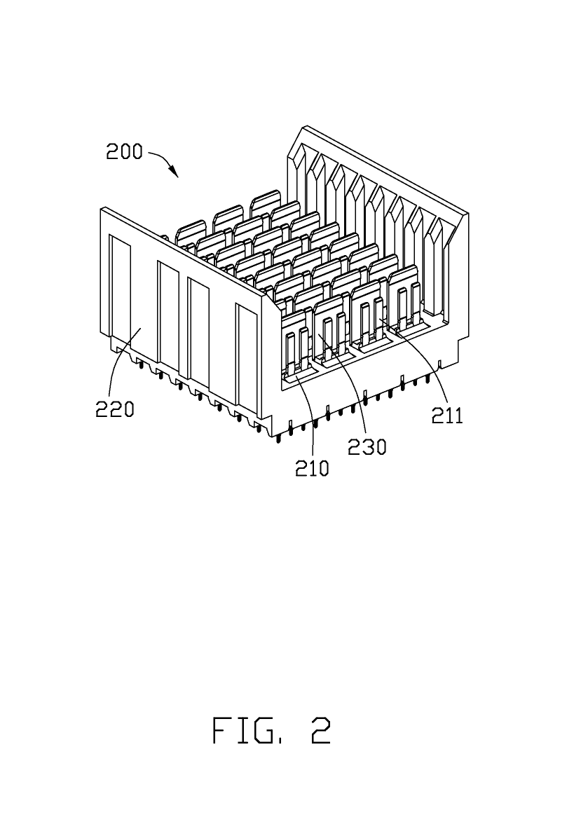

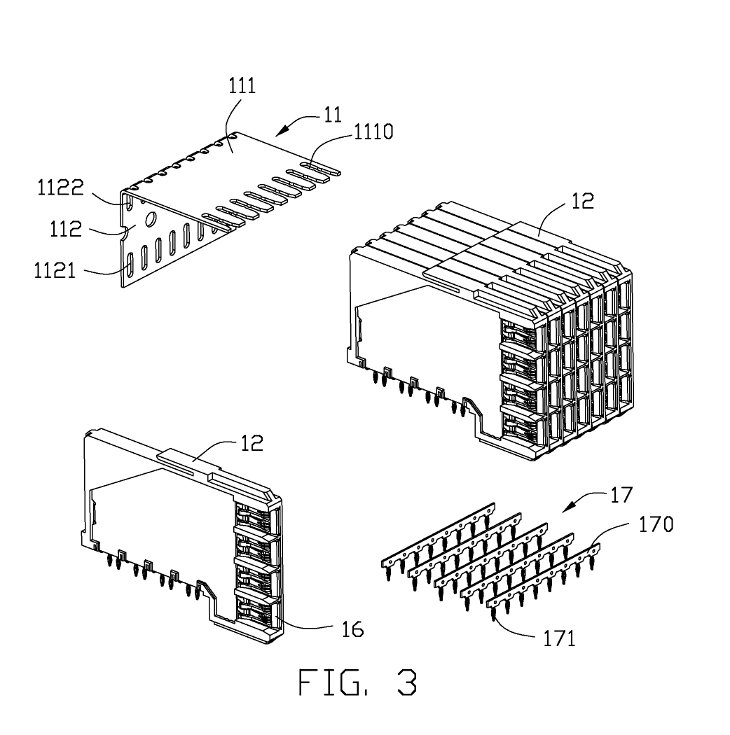

Referring to FIGS. 1-3, a receptacle connector 100 in accordance with the present invention is designed to be mounted to a printed circuit board 500 and mated with a header 200. The header 200 includes a U-shaped base housing 220, a plurality of terminal module 210 each having a pair of terminals 211 molded therein, and a plurality of shielding blades 230.

The receptacle connector 100 includes a number of frames 12 transversely stacked together, a L-shaped retainer 11, and a number of grounding bridges 17. The retainer 11 is preferably punched from a metal plate. The retainer 11 comprises a top wall 111 and a rear wall 112. The retainer 11 defines a number of cutouts 1110 on a front edge of the top wall 111, a number of cutouts 1121 on a lower edge of the rear wall 112, and a number of cutouts 1122 between the top wall 111 and the rear wall 112. The grounding bridge 17 has a base portion 170, and a plurality of grounding legs 171 each extending downwardly from the base portion 170 configured for mounting into a mounting hole 501 on the printed circuit board 500.

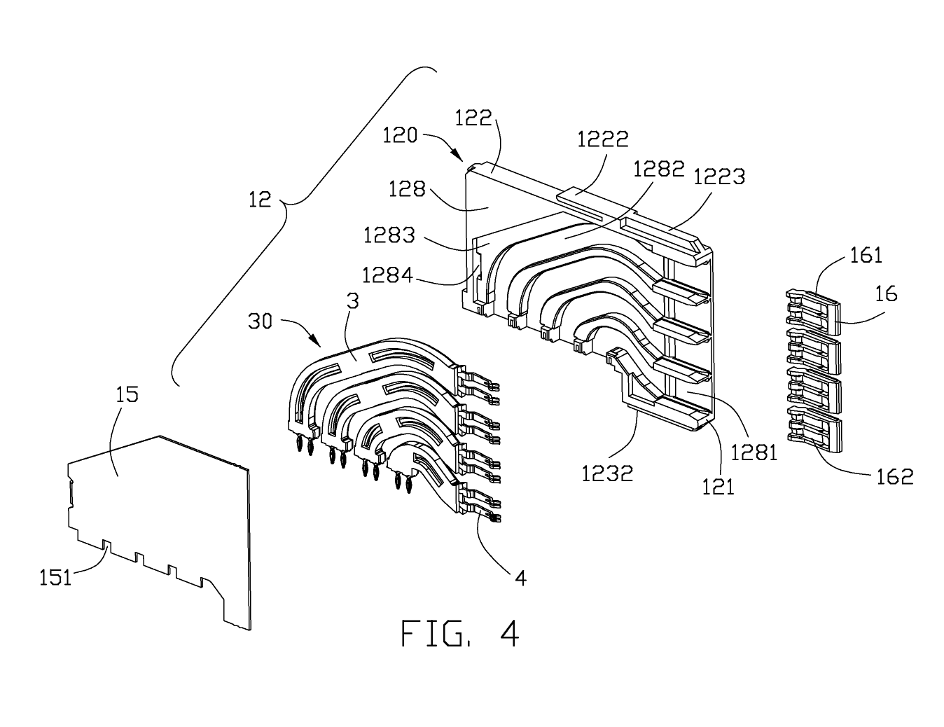

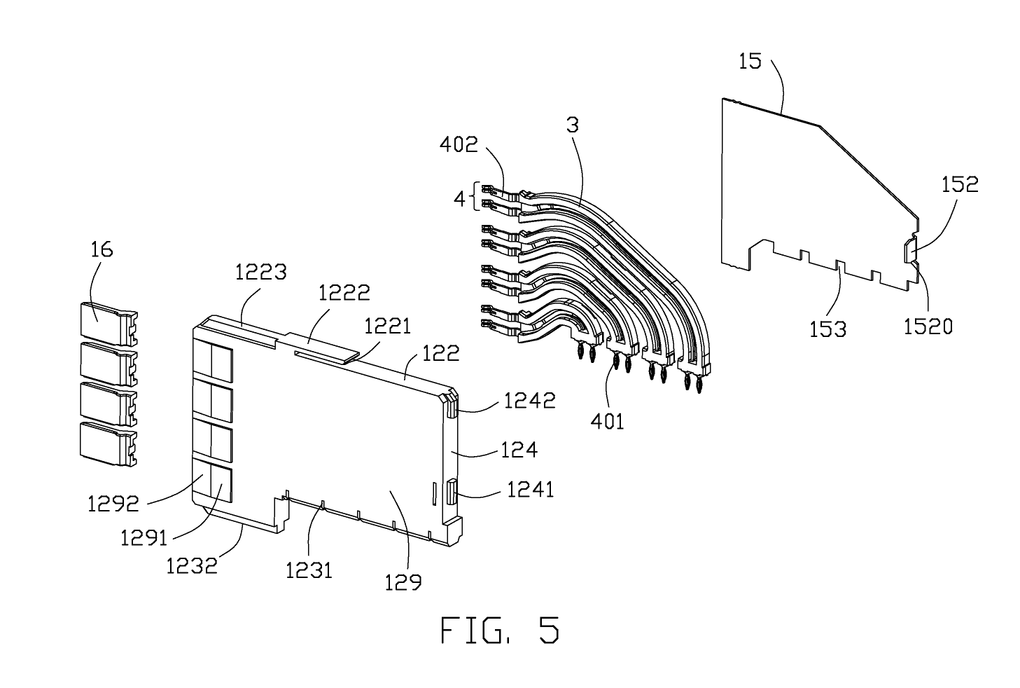

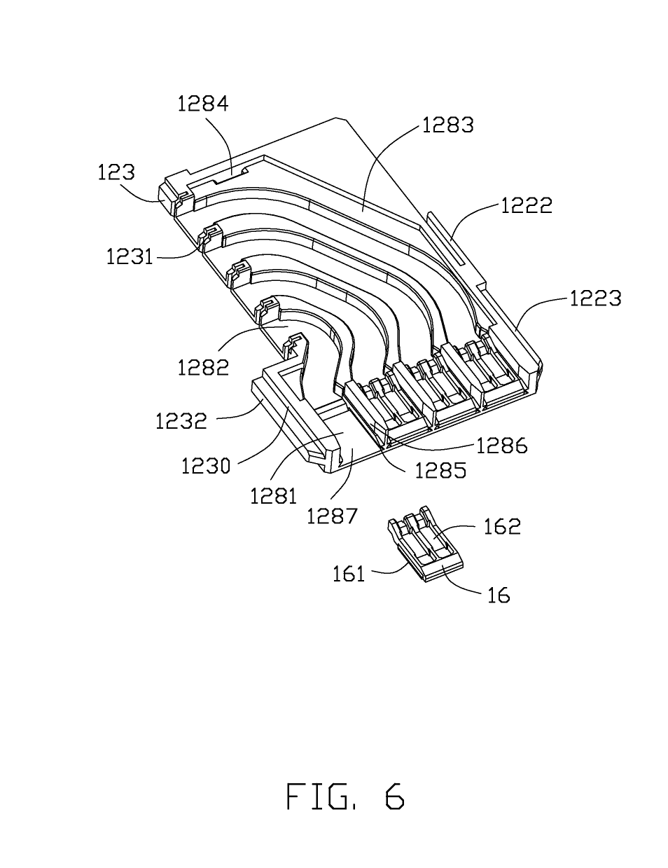

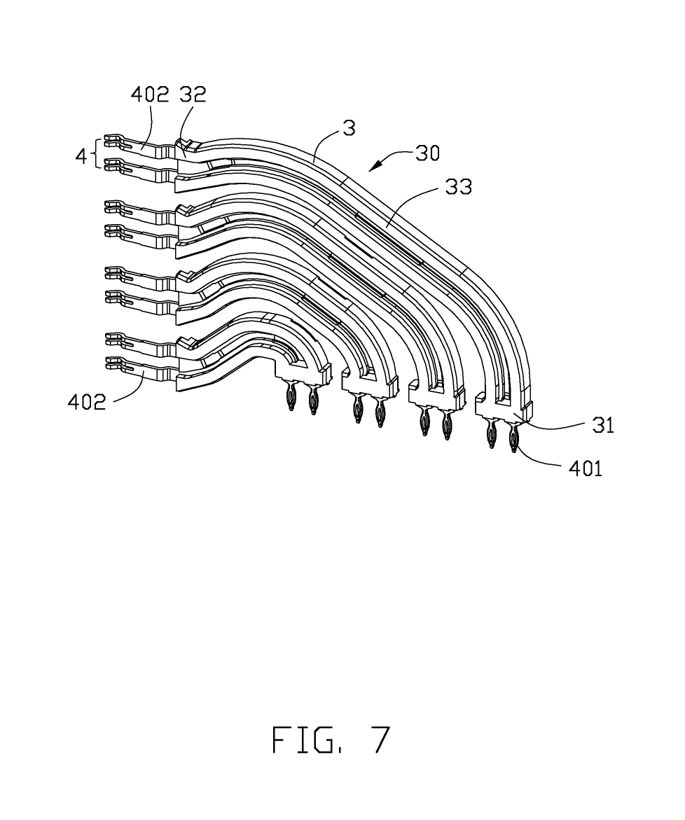

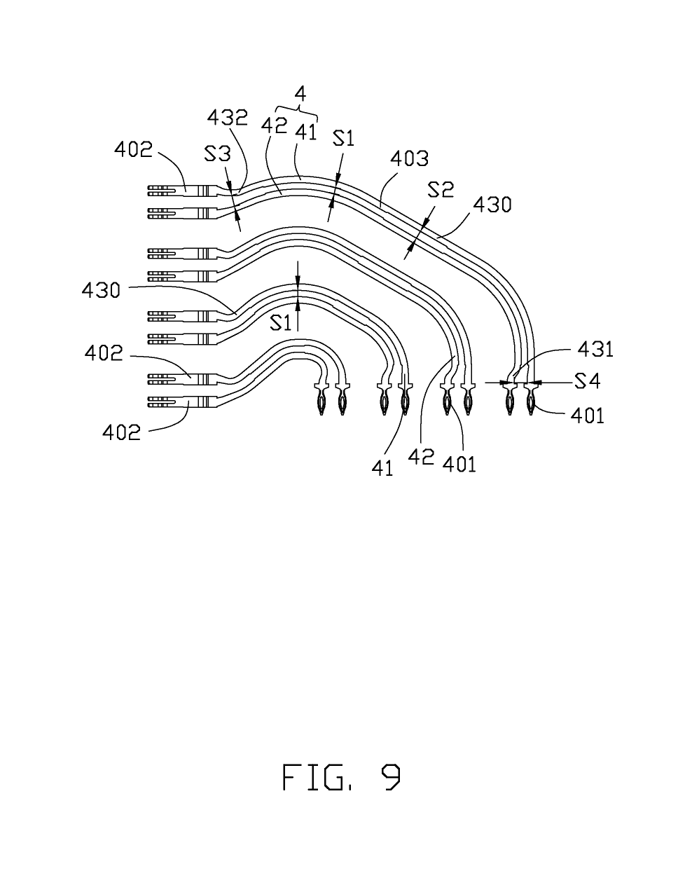

Referring to FIGS. 4-9, each frame 12 includes a conductive housing 120 having a first side 128 and an opposite second side 129. The conductive housing 120 is made from die casting metal or conductive plastic, or insulating piece plated with metal plating. In a preferred embodiment, the conductive housing 120 is made from thermoplastic plated with metal material, such as Chromium, Copper, Tin or Gold. The first side 128 defines a plurality of grooves 1282 thereon. The frame 12 further includes a plurality of contact modules 30 and a plurality of insulating spacers 16. The contact module 30 comprises an insulating stabilizer 3 and a pair of differential contact 4 insert-molded therein. The insulating spacer 16 is mounted in the groove 1282 and aligned to a front side of the insulating stabilizer 3, such that the groove 1282 is filled with a contact module 30 and an insulating spacer 16.

The differential contact 4 includes a first contact 41 and a second contact 42 separately fixed by the insulating stabilizer 3. The differential contact 4 comprises a mounting portion 401 vertically extending out of a bottom side of the stabilizer 3 configured for connecting with the circuit board 500, a mating portion 402 horizontally extending out of a front side of the stabilizer 3 configured for mating with the header 200, and an intermediate portion 403 connecting the mounting portion 401 and the mating portion 402. Both the first contact 41 and the second contact 42 are embedded into the insulating stabilizer 3 at the intermediate portion 403 and at least partially exposed to air from the intermediate portion 403.

The first contact 41 and the second contact 42 are positioned parallel with each other in a first distance Si and a second distance S2 along the intermediate portion 403. The first distance Si is smaller than the second distance S2. The second distance S2 is smaller than the third distance S3. The second distance S2 is smaller than the fourth distance S4 too. The intermediate portion 403 has a front portion 432 adjacent to a front side of the insulating stabilizer 3, and a lower portion 431 adjacent to a bottom side of the insulating stabilizer 3. The front portion 432 has a third distance S3 between the first contact 41 and the second contact. The lower portion 432 has a fourth distance S4 between the first contact 41 and the second contact 42. Both the third distance S3 and the fourth distance S4 are larger than the second distance S2. Preferablely, the fourth distance S4 is larger than the third distance S3, due to the mouting portion 401 should to be stronger than the mating portion 402.

The conductive housing 120 further has a front edge 121, a rear edge 124 apposing the front edge 121, a top edge 122, and a lower edge 123 apposing the top edge 122. A flange 1242 is formed on the rear edge 124 adapted to assemble with the cutout 1121 of the retainer 11. A flange 1242 is formed on the rear edge 124 adjacent to the top edge 122 adapted to assemble with the cutout 1122. The top edge 122 has a flange 1221 received by the cutout 1110 of the retainer 11, a covering portion 1222 extending out of the flange 1221 configured for covering the cutout 1110, and a upper leading edge 1223 configured for leading the header 200. The lower edge 123 has a number of slit 1231, an extending portion 1230, and a lower leading edge 1232 configured for leading the header 200. Each grounding bridge 17 is mounted into the aligned slits 1231 after the frames 12 are stacked.

The groove 1282 has a front notch 1281 adjacent to the front edge 121 comprising a pair of side walls 1286 and a bottom wall 1287. A number of bulges 1291 extending out of the second side 129 of the conductive housing 120. Each bulge 1291 is formed opposing to the front notch 1281 of the groove 1282. The bulge 1291extends into a front notch 1281 of another adjacent-stacked frame 12 configured for forming a mating room 160 therebetween. The bulge 1291 has a bezel 1292 configured for leading the shielding blades 230 when the receptacle connector 100 is mating with the header 200.

The insulating spacer 16 has a pair of receiving space 162 configured for receiving the mating portion 402 of each pair of the differential contact 4. The insulating spacer 16 is mounted into the groove 1282 adjacent to the front side of the insulating stabilizer 3. Each insulating spacer 16 has at least a rib 161 engaged with a slot 1285 defined on one of the side walls 1286 of the front notch 1281.

The conductive housing 120 further has a recess 1283 on the first side 128. The recess 1283 defines at least a mounting hole 1284 thereon. The frame 12 further includes a shielding plate 15 mating with the recesses 1283. The shielding plate 15 has at least a mounting leg 152 adapted to mate with the mounting hole 1284. The mounting leg 152 forms a barb 1520 thereon configured for mating with the mounting hole 1284 tightly. The shielding plate 15 and the grooves 1282 of the conductive housing 120 define a number of shielding passages (not numbered) to shield each differential contacts 4, such that the differential signal's cross talk reduced.

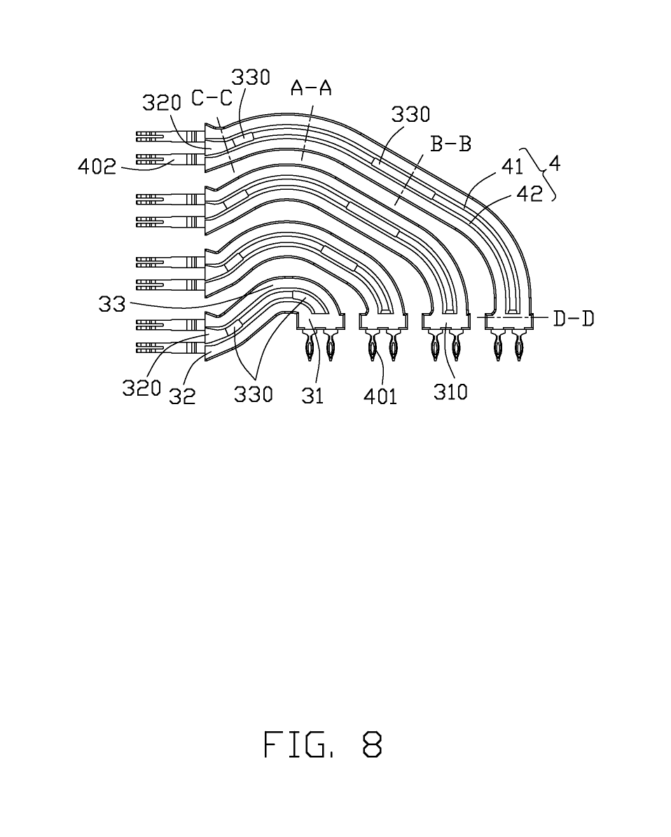

Referring to FIGS. 8, 9 and 10A-10D, the insulating stabilizer 3 has a front portion 32 configured for embedding the front portion 432 of the differential contact 4, a rear portion 31 configured for embedding the lower portion of the differential contact 4, and a middle portion 33 connecting the first contact 41 and the second contact 42 over the intermediate portion 403. The front portion 32 of the insulating stabilizer 3 has a front connective part 320 projecting between the first contact 41 and the second contact 42. The rear portion 31 of the insulating stabilizer 3 has a rear connective part 310 projecting between the first contact 41 and the second contact 42. The insulating stabilizer 3 further has a middle connective part 330 connecting the first contact 41 and the second contact 42 at the intermediate portion 403 under the second distance S2. All of the rear connective part 310, front connective part 320 and middle connective part 330 are configured for strengthening the structure of the differential contact 4.

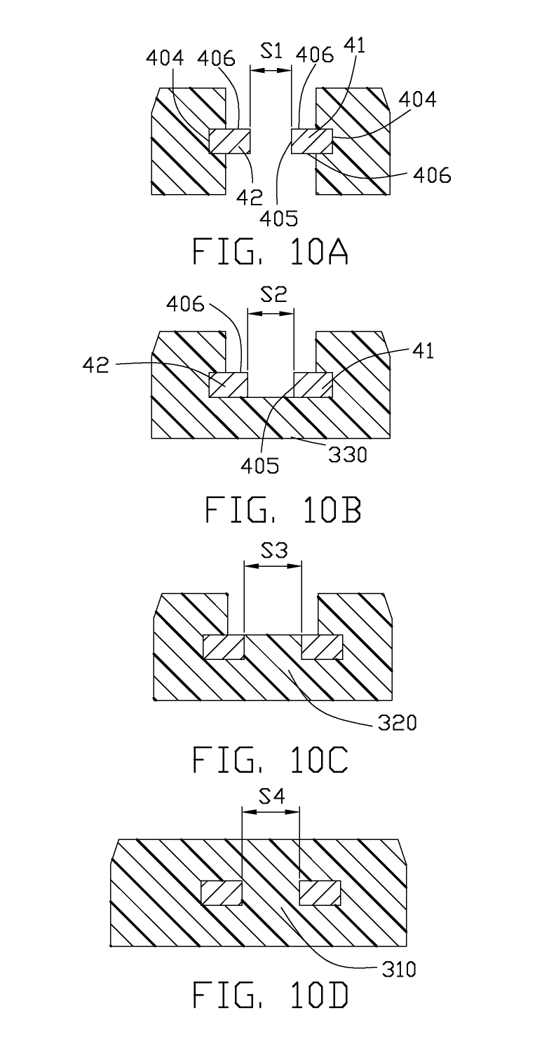

In order to improve the performance of the high speed signal transmission of the differential contact 4, the thickness of the middle connective part 330 along the transverse direction is smaller than the rear connective part 310, and smaller than the front connective part 320. In another words, the cross section of the insulating stabilizer 3 along the transverse direction under the first distance 51 (FIG. 10A) is smaller than the cross section of the middle connective part 330 (FIG. 10B). The cross section of the middle connective part 330 along the transverse direction is smaller than the cross section of the rear connective part 310 (FIG. 10D) and the front connective part 320 (FIG. 10C). The cross section of the front connective part 320 along the transverse direction is smaller than the cross section of the rear connective part 310.

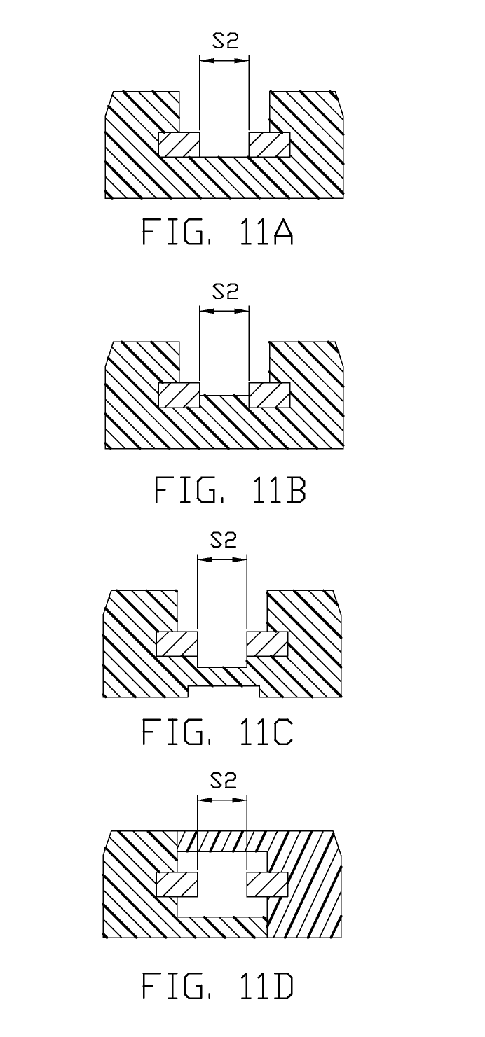

The middle connective part 330 is formed for keeping the distance between the first contact 41 and the second contact 42 (including the first distance S1 and the second distance S2), however, the thickness of the middle connective part 330 influences the impedance of the differential contact 4. The middle connective part 330 could be changed into different configurations (see FIG. 11A-11D), so that the middle connective part 330 could keep impedance matched with the other part of the differential contact 4.

The first contact 41 and the second contact 42 are integrate punched from a metal plate (not shown) and kept in a planar shape. Each of the first contact 41 and the second contact 42 has an outer edge 404 opposing to each other and embedded into the stabilizer 3, an inner edge 405 facing to each other, and two side edges 406 connecting the inner edge 405 and the outer edge 404. The side edge 406 is partially exposed to air along the intermediate portion 403. The differential contact 4 having a first distance S1 between the inner edges 405 when each of the differential contact 4 has two side edges partially and the inner edge totally exposed to the air. The differential contact 4 has a second distance S2 between the inner edges 405 when each of the differential contact 4 has one side edge 406 partially and the inner edge 405 totally exposed to the air. The differential contact 4 has a third distance S3 between the inner edges 405 when each of the differential contact 4 only has one side edge 406 partially exposed to the air. As described before, the first distance S1 is smaller than the second distance S2, and the second distance S2 is smaller than the third distance S3.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A receptacle connector comprising a plurality of frames transversely stacked together, each frame comprising:
a conductive housing having a first side and an opposite second side, a front edge and a lower edge vertical to the front edge, and a plurality of grooves disposed on the first side and extending from the front edge to the lower edge;
a plurality of insulating stabilizers mounted in corresponding grooves; and
plural differential pairs of contacts each separately molded in a corresponding stabilizer, each contact of a differential pair of contacts having an outer edge embedded into the stabilizer, an opposing inner edge, and two side edges each connecting the inner edge and the outer edge, said side edge at least partially exposing to air; wherein each differential pair of contacts are spaced:
a first distance between the inner edges where each contact has both side edges partially exposed to air and the inner edge totally exposed to air,
a second distance between the inner edges where each contact has one side edge partially exposed to air and the inner edge at least partially exposed to air, and
a third distance between the inner edges where each contact has only one side edge partially exposed to air; and wherein
the first distance is less than the second distance, and the second distance is less than the third distance.

2. The receptacle connector as claimed in claim 1, wherein the pair of contacts each have a mating portion, a mounting portion, and an intermediate portion connecting said mating portion and said mounting portion, and wherein the intermediate portions of the differential pair are spaced the third distance at a region adjacent to the mating portions.

3. The receptacle connector as claimed in claim 2, wherein the differential pair are spaced a fourth distance at a region adjacent to the mounting portions, said fourth distance being greater than the second distance.

4. The receptacle connector as claimed in claim 3, wherein the fourth distance is greater than the third distance.

5. The receptacle connector as claimed in claim 4, wherein a dimension of the stabilizer along the transverse direction at the fourth distance is greater than a dimension of the stabilizer along the transverse direction at the third distance.

6. The receptacle connector as claimed in claim 2, wherein said intermediate portion is embedded in the stabilizer, said mating portion horizontally extending out of the stabilizer, said mounting portion vertically extending out of the stabilizer, and the frame includes a plurality of insulating spacers each receiving said mating portions of the differential pair, said insulating spacer mounted in the groove of the conductive housing aligned to the insulating stabilizer.

7. The receptacle connector as claimed in claim 6, wherein the insulating spacer has at least one rib, and each groove of the conductive housing has at least one slot receiving the at least one rib.

8. The receptacle connector as claimed in claim 6, wherein the conductive housing has a plurality of bulges on the second side, said bulge extending into the groove of an adjacent conductive housing, the insulating spacer facing said bulge to form a mating room therebetween.

9. The receptacle connector as claimed in claim 8, wherein the bulges are configured for electrically mating with a header.

10. The receptacle connector as claimed in claim 1, further including an L-shaped retainer having a top wall and a rear wall each defining a plurality of cutouts, and wherein said conductive housing has a lower edge, a top edge, a front edge, and a rear edge, each of the top edge and the rear edge forming at least one flange, said cutout engaging the at least one flange.

11. The receptacle connector as claimed in claim 10, wherein the retainer is made of conductive material and electrically contacting with the conductive housings.

12. A receptacle connector comprising:
a plurality of frames stacked with one another along a transverse direction;
a plurality of grooves formed in each of said frames in relatively a parallel relation;
a plurality of contact modules disposed in said grooves, respectively, each of said contact module including a pair of differential contacts extending in relatively the parallel relation and partially embedded within an insulative stabilizer which is compliantly received in the corresponding groove, the pair of differential contacts defining opposite mating and mounting end sections and intermediate section therebetween, a distance between the pair of differential contacts varying along an extension direction of said pair of differential contacts; wherein
the distance at two opposite mating and mounted end sections are larger than that of the intermediate section, and a cross-section of the pair of differential pair is exposed to an exterior at the intermediate section more than at the end section.

13. The receptacle connector as claimed in claim 12, wherein each of said differential contacts defines four sides of the cross-section, and at least two of said four sides of the cross-section are exposed to the exterior at the intermediate section while at most one of said four sides are exposed to the exterior at the end section.

14. The receptacle connector as claim in claim 13, wherein the cross-section of each of said differential contacts is exposed to an exterior with only one side at the mating end section while with no side at the mounting end section.

15. The receptacle connector as claimed in claim 13, wherein the distance varies in the intermediate section, and the distance in a first position of the intermediate section is smaller than that in the second position under a condition that the cross-section of each of the differential contacts is exposed to the exterior with three sides at the first position while with the two sides at the second position.

16. The receptacle connector as claimed in claim 15, wherein the second position is around a middle region of each of the differential contacts.

17. A receptacle connector comprising:
a plurality of frames stacked with one another along a transverse direction;
a plurality of grooves formed in each of said frames in relatively a parallel relation;
a plurality of contact modules disposed in said grooves, respectively, each of said contact module including a pair of differential contacts extending in relatively the parallel relation and partially embedded within an insulative stabilizer which is compliantly received in the corresponding groove, the pair of differential contacts defining opposite mating and mounting end sections and intermediate section therebetween, a distance between the pair of differential contacts varying along an extension direction of said pair of differential contacts; wherein
each of said grooves defines around the mating end sections of the corresponding contacts a notch with a dovetailed recess thereof, a plurality of insulating spacers disposed in the corresponding notches to protectively receive the mating end section of the pair of differential contacts, respectively; wherein
each of the insulating spacers defines a dovetailed protrusions snugly received in the corresponding dovetailed recess in an interference fit.

18. The receptacle connector as claimed in claim 17, wherein each of said insulating spacers defines a pair of channels in which the mating end sections of said pair of differential contacts are deflectably received.

19. The receptacle connector as claimed in claim 18, wherein the stabilizer is located outside of the correspond notch.

20. The receptacle connector as claimed in claim 19, wherein a rear end of each of the insulating spacers is seated upon a transverse bar formed on an inner surface of the corresponding groove.
